(19) United States
(12) Patent Application Publication
(10) Pub. No.: US 2015/0092540 A1
(43) Pub. Date: Apr. 2, 2015

(54) System and Method for Traffic Offload

(71) Applicant: Broadcom Corporation, Irvine, CA (US)

(72) Inventors: Amit CHOUDHARY, Bangalore (IN); Arzad Kherani, Bangalore (IN)

(73) Assignee: Broadcom Corporation, Irvine, CA (US)

(21) Appl. No.: 14/041,854

(22) Filed: Sep. 30, 2013

(51) Int. Cl. H04W 36/22; H04W 28/02

(52) U.S. Cl. CPC H04W 36/22; H04W 28/0289
USPC 370/230

(57) ABSTRACT

Embodiments of the disclosure generally relate to a system and method for traffic offload from a first access technology to a second access technology. For example, packets originally destined for transmission over a bearer channel associated with Long Term Evaluation (LTE) can be offloaded to a Wi-FI bearer channel in a seamless manner when available, or a non-seamless manner.

### BACKGROUND OF THE DISCLOSURE

1. Field of the Disclosure

Embodiments of the disclosure generally relate to a system and method for traffic offload from a first access technology to a second access technology.

2. Background

Mobile data traffic has been growing rapidly. Some estimate that global mobile data traffic will increase 13-fold between 2012 and 2017. This rapid increase in mobile data traffic may lead to network congestion, and result in diminished quality of service of a mobile network.

Some conventional mobile devices include multiple interfaces that implement different access technologies—such as access technologies complying with the 3rd Generation Partnership Project's (3GPP) specifications, and access technologies that comply with other specifications (e.g., Wi-Fi, WiMAX, CDMA2000, WLAN)—for accessing a packet data network (PDN). In some devices, these multiple interfaces can be used to simultaneously access a PDN using more than one interface.

### BRIEF DESCRIPTION OF THE DRAWINGS/FIGURES

FIG. 1 illustrates an example system that supports coexisting wireless connections between user equipment (UE) and an external network via different access technologies.

FIG. 2 illustrates an example system for connecting to an external network via an evolved packet system (EPS).

FIG. 3 illustrates an example table relating access point names (APN), EPS bearers, and Internet protocol (IP) flows.

FIG. 4 illustrates an example apparatus that supports coexisting wireless connections to an external network via different access technologies, and traffic offload among the coexisting wireless connections.

FIG. 5 illustrates an example method for wireless offload from a first wireless connection to a second wireless connection.

FIG. 6 illustrates an example message sequence chart (MSC) for seamless offload from a first wireless connection to a second wireless connection.

FIG. 7 illustrates an example MSC for non-seamless offload from a first wireless connection to a second wireless connection.

### DETAILED DESCRIPTION OF EXAMPLE EMBODIMENTS

While the present disclosure is described herein with illustrative embodiments for particular applications, it should be understood that the disclosure is not limited thereto. A person skilled in the art with access to the teachings provided herein will recognize additional modifications, applications, and embodiments within the scope thereof and additional fields in which the disclosure would be of significant utility.

The terms “embodiments” or “example embodiments” do not require that all embodiments include the discussed feature, advantage, or mode of operation. Alternate embodiments may be devised without departing from the scope or spirit of the disclosure, and well-known elements may not be described in detail or may be omitted so as not to obscure the relevant details. In addition, the terminology used herein is for the purpose of describing particular embodiments only and is not intended to be limiting. For example, as used herein, the singular forms “a,” “an” and “the” are intended to include the plural forms as well, unless the context clearly indicates otherwise. It will be further understood that the terms “comprises,” “comprising,” “includes” and “including,” when used herein, specify the presence of stated features, integers, steps, operations, elements, and components, but do not preclude the presence or addition of one or more other features, integers, steps, operations, elements, components, or groups thereof.

Software described throughout this disclosure may be embodied as one or more computer-readable instruction(s) on a computer-readable storage device-such as a persistent memory device (e.g., read-only memory (ROM), flash memory, a magnetic storage device, an optical disc, and the like), a non-persistent memory device (e.g., random-access memory (RAM)), and the like—that can be executed by a processor to perform one or more operations.

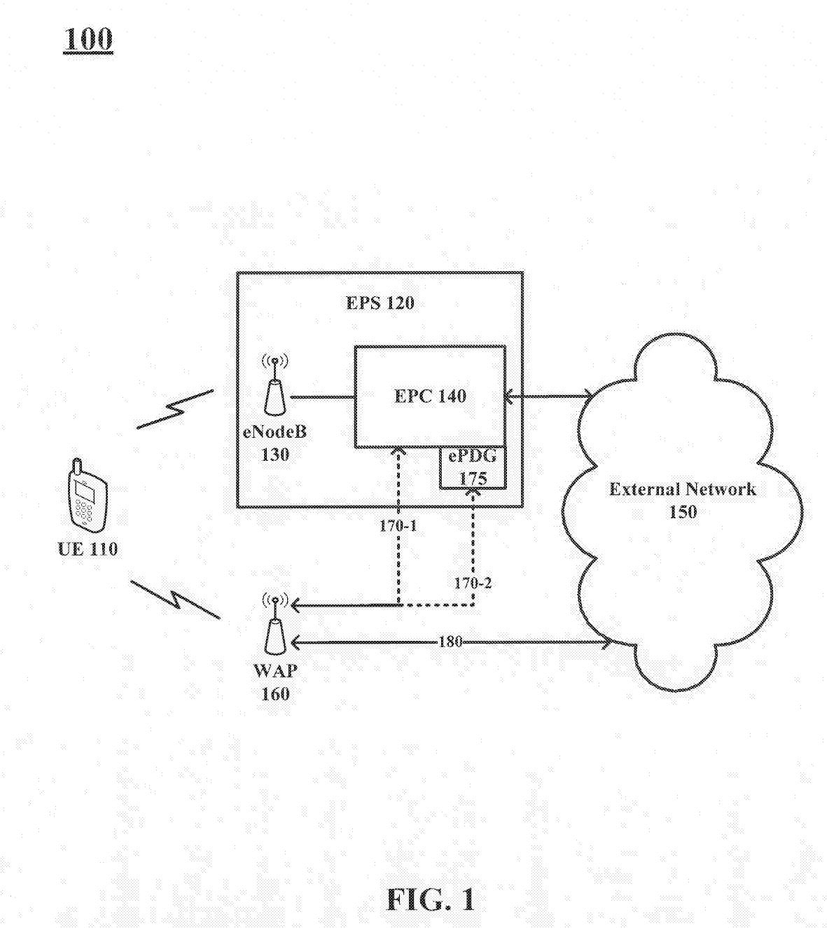

FIG. 1 illustrates an example system 100 that supports coexisting wireless connections between user equipment (UE) and an external network via different access technologies. The system 100 includes user equipment (UE) 110, an evolved packet system (EPS) 120, an external network 150, and a wireless access point (WAP) 160. A person skilled in the art would understand that the system 100 may include one or more components (e.g., implemented in hardware, software, or any combination of hardware and software) in addition to the components shown in the embodiment of FIG. 1 without departing from the scope of this disclosure.

In the example embodiment of FIG. 1, the UE 110 is any device capable of establishing coexisting wireless connections to the external network 150 via the eNodeB 130 and the WAP 160. Examples of the UE 110 include (but are not limited to) a mobile computing device—such as a laptop computer, a tablet computer, a mobile telephone or smartphone, a “phablet,” a personal digital assistant (PDA), and the like; a wearable computing device-such as a computerized wrist watch or “smart” watch, computerized eyeglasses, and the like; and a stationary computing device—such as a personal computer (PC), a desktop computer, a computerized kiosk, and the like.

The EPS 120 of FIG. 1 comprises an evolved packet core (EPC) 140 together with an evolved radio access network (evolved universal terrestrial radio access (E-UTRA) and evolved universal terrestrial radio access network (E-UTRAN)). The EPC 140 is the core network architecture of the 3rd Generation Partnership Project's (3GPP) long term evolution (LTE) system. The EPC 140 is a packet-switched architecture that relies on Internet Protocol (IP) to transport services. The EPC 140 is connected to the external network 150, which may include one or more packet data networks (PDN), such as (but not limited to) an Internet protocol (IP) Multimedia Core Network Subsystem (IMS) and the Internet. As an example, the EPC 140 may transport a voice over LTE (VoLTE) service provided by an IMS to the UE 110. As another example, the EPC 140 may transport Email, video streaming, and web browsing services provided by the Internet to the UE 110.

The evolved radio access network of the EPS 120 of FIG. 1 includes the eNodeB 130, which is one of a plurality of base stations that are networked together to form the E-UTRAN. A person skilled in the art would understand that the EPS 120 is not limited to a single base station as illustrated in FIG. 1, but may include any number of eNodeBs. Each eNodeB of the EPS 120, including the eNodeB 130, is connected to the EPC 140. The UE 110 illustrated in FIG. 1 may access (via E-UTRA) the eNodeB 130 to connect to the EPC 140. Because the EPC 140 is connected to the external network 150, the UE 110 can access services provided by the external network 150 through the EPS 140. Accessing, by the UE 110, the EPC 140 via the eNodeB 130 may be referred to as a “3GPP access.”

The WAP 160 of FIG. 1 supports wireless communication with the UE 110 over a non-3GPP technology, such as Wi-Fi, WiMAX, CDMA2000, and wireless local area network (WLAN). The WAP 160 may provide access to the external network 150 through the EPC 140. Accessing, by the UE 110, the EPC 140 via the WAP 160 may be referred to as a “non-3GPP access.” A non-3GPP access may be “trusted” (e.g., connection 170-1), where the non-3GPP technology can interact directly with the EPC 140; or “untrusted” (e.g., connection 170-2) where the non-3GPP technology interacts with the EPC 140 via an evolved packet data gateway (ePDG) 175—which is a network entity that can provide security mechanisms. As illustrated in FIG. 1, the WAP 160 may also connect to the external network 150 via the connection 180, which is a connection that does not traverse the EPC 140. While not shown, the WAP 160 may include or be connected to a modem or any other mechanism that allows the UE 110 to connect to and communicate with the external network 150 without traversing the EPC 140.

FIG. 1 shows four potential access paths that the UE 110 may establish to connect to the external network 150, three of which traverse the EPC 140: (1) the UE 110 may connect to the EPC 140 via the E-UTRAN (via eNodeB 130), and then to the external network 150 through the EPC 140; (2) the UE 110 may connect to the EPC 140 via the WAP 160 through a trusted connection 170-1, and then to the external network 150 through the EPC 140; and (3) the UE 110 may connect to the EPC 140 via the WAP 160 through an untrusted connection 170-2 (where the WAP 160 connects to the EPC 140 through the ePDG 175), and then to the external network 150 through the EPC 140. In the fourth path (4), the UE 110 connects to the external network 150 without traversing the EPC 140, which is illustrated by the connection 180.

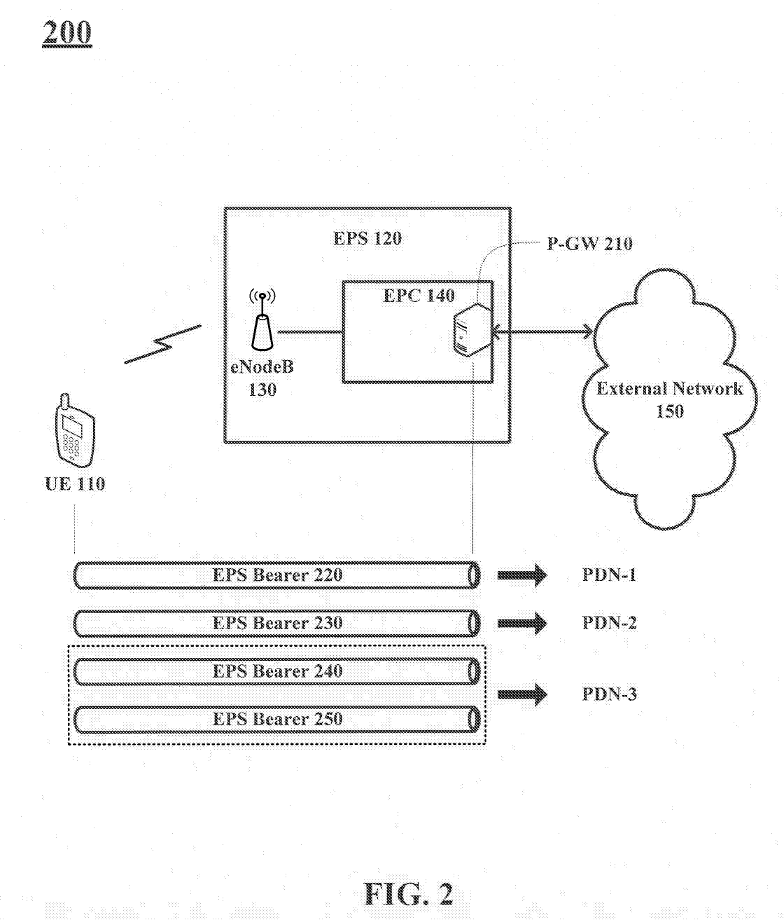

FIG. 2 illustrates an example system 200 for connecting to an external network via an EPS. The system 200 illustrates examples of the first access path described above, i.e., the UE 110 connects to the external network 150 through the EPS 120. In FIG. 2, the EPC 140 includes a packet data network gateway (P-GW) 210, which is the mechanism that connects the EPC 140 to the external network 150, and routes packets to and from the external network 150. The P-GW 210 of FIG. 2 may connect the EPC 140 to, e.g., an IMS or the Internet. While not shown, the EPC 140 of FIG. 2 may include a plurality of P-GWs, each connecting the EPC 140 to a PDN. Each PDN may be identified by an access point name (APN). The P-GW 210 is responsible for assigning the UE 110 one or more IP addresses that are associated with the PDN that is connected to the EPC 140 through the P-GW 210. IP address assignment may occur when the UE 110 is powered on and is within range of the eNodeB 130.

A person skilled in the art would understand that the EPC 140 may include one or more components (e.g., implemented in hardware, software, or any combination of hardware and software) in addition to the components shown in the embodiment of FIG. 2 without departing from the scope of this disclosure. For example, an EPC generally includes a home subscriber network (HSS) that contains user-related and subscriber-related information, a serving gateway (S-GW) that connects the EPC 140 to the E-UTRAN, and a mobile management entity (MME) that may handle signaling related to mobility and security for E-UTRAN access.

In the example system 200 of FIG. 2, the UE 110 establishes three PDN connections through the EPS 120: PDN-1, PDN-2, and PDN-3. Each PDN connection includes one or more EPS bearers, which, in this example, may be considered “virtual connections” or “communication tunnels” between the UE 110 and the P-GW 210. In FIG. 2, the PDN-1 connection includes an EPS bearer 220; the PDN-2 connection includes an EPS bearer 230; and the PDN-3 connection includes EPS bearers 240 and 250. The EPS bearers within a PDN connection share the same UE IP address and APN—e.g., the EPS bearers 240 and 250 of the connection to PDN-3 share the same UE 110 IP address and APN.

An EPS bearer may be a default EPS bearer or a dedicated EPS bearer. A default EPS bearer may be created upon the establishment of a PDN connection, whereas a dedicated EPS bearer may be established if a service (e.g., invoked by the UE 110) requires a specific quality of service (QoS) or other handling. In one example, a default EPS bearer 240 is created when the UE 110 establishes the PDN-3 connection. In one embodiment, the UE 110 activates an application that invokes a service requiring a specific QoS (e.g., conversational voice, conversational video (live or buffered streaming), real-time gaming, etc.)—triggering the establishment of the dedicated EPS bearer 250. The UE 110 may release a dedicated EPS bearer when the service requiring the specific QoS has completed, and may release a default EPS bearer when the PDN connection is released.

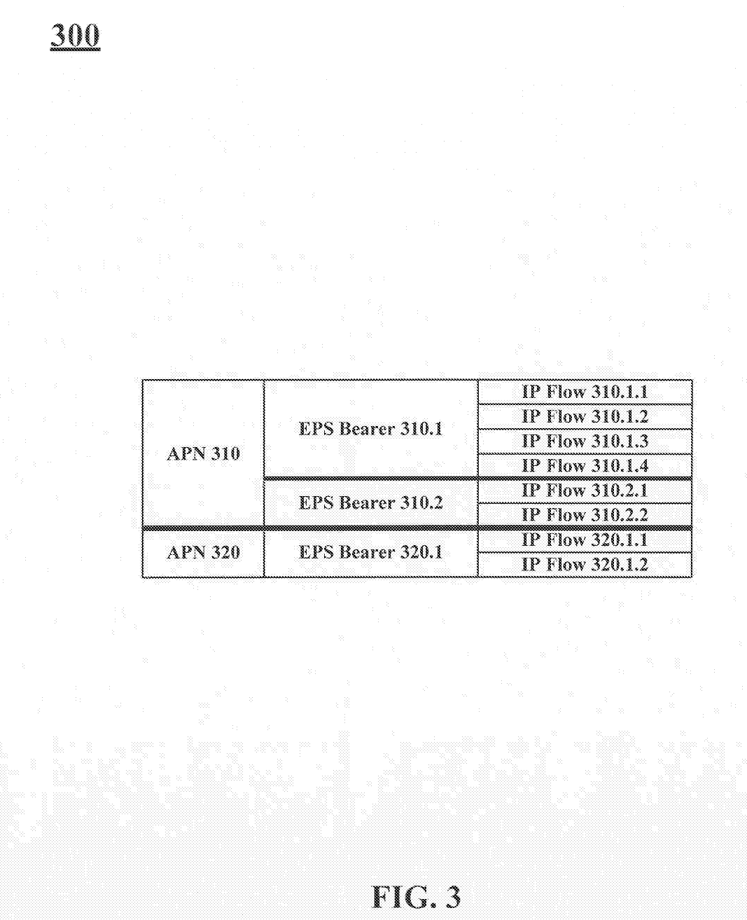

Each of the EPS bearers shown in FIG. 2 may support one or more IP flows (i.e. Internet Protocol packet flows), which is illustrated in the example table 300 of FIG. 3. The table 300 illustrates, in this example, the relationship between PDN connections (as identified by APNs), EPS bearers, and IP flows. In FIG. 3, the PDN connection identified by APN 310 includes two EPS bearers 310.1 and 310.2. Four IP flows (310.1.1-310.1.4) are associated with the EPS bearer 310.1, and two IP flows (310.2.1 and 310.2.2) are associated with the EPS bearer 310.2. The table 300 also illustrates the PDN connection identified by APN 320, which includes the EPS bearer 320.1. Two IP flows (320.1.1 and 320.1.2) are associated with the EPS bearer 320.1 in this example. To further illustrate, the APN 310 of FIG. 3 may identify the Internet, the EPS bearer 310.2 may be a dedicated EPS bearer, and the IP flows 310.2.1 and 310.2.2 may be associated with Email and file transport protocol (FTP), respectively. Any other relationship, configuration, example, etc. that is apparent to a person skilled in the art is within the scope of this disclosure.

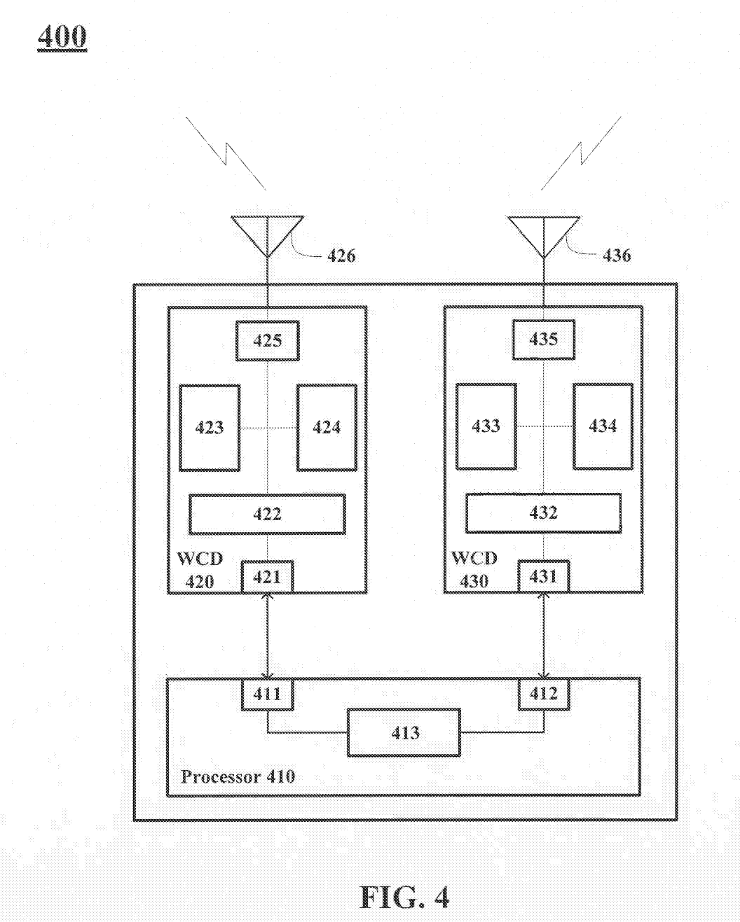

Turning now to FIG. 4, an example apparatus 400 that supports coexisting wireless connections to an external network via different access technologies, and traffic offload among the coexisting wireless connections is shown. Accordingly, the apparatus 400 of FIG. 4 may be an example of UE 110. The example apparatus 400 of FIG. 4 supports offloading data traffic (e.g., IP packets) associated with one or more PDN connections, EPS bearers, or IP flows from a first wireless connectivity device (WCD) to a second WCD.

As shown in FIG. 4, the apparatus 400 includes a processor 410 that is connected to each of a first WCD 420 and a second WCD 430. While only two WCDs are depicted in FIG. 4, the apparatus 400 may include more than two WCDs. A person skilled in the art would understand that the apparatus 400 may include one or more components (e.g., implemented in hardware, software, or any combination of hardware and software) in addition to the components shown in the embodiment of FIG. 4 without departing from the scope of this disclosure. In one example, the apparatus 400 may include, e.g., an input device for accepting user input; an output device to present aural, visual, and/or tactile output; a memory system for storing data and executable code (e.g., one or more applications); a power source (e.g., a battery); various interfaces for connecting other devices (e.g., a peripheral device); and any other component known to a person skilled in the art.

Some or all of the components of the apparatus 400 may be implemented as a single integrated circuit, or may be implemented as different integrated circuits that are communicatively connected (e.g., via wires or wirelessly). In one example, the processor 410 and both WCDs 420 and 430 are implemented as a single integrated circuit. In another example, the processor 410, the WCD 420, and the WCD 430 are each implemented as separate integrated circuits. Separate integrated circuits may be mounted on a printed circuit board (PCB) along with other circuits, devices, components, and the like. All other configurations apparent to a person skilled in the art are within the scope of this disclosure.

The apparatus 400 of FIG. 4, via WCDs 420 and 430, may establish coexisting connections to and communicate with one or more external networks via different wireless access technologies. The WCD 420 may support a 3GPP access (e.g., LTE) and the WCD 430 may support a non-3GPP access (e.g., Wi-Fi, WiMAX, CDMA2000, etc.), or vice versa. In one example, the WCD 420 is a LTE connectivity device, the WCD 430 is a Wi-Fi connectivity device, and both WCDs 420 and 430 establish connections to and simultaneously communicate with the Internet. In another example, the WCD 420 is a Wi-Fi connectivity device that is connected to an IMS and the Internet, and the WCD 430 is an LTE connectivity device that is connected to the Internet. Again, all other configurations apparent to a person skilled in the art are within the scope of this disclosure.

Like the UE 110 of FIG. 2, the apparatus 400 of FIG. 4 may connect to a PDN over an EPS, and establish one or more EPS bearers. In one example, the WCD 420 supports 3GPP accesses, allowing the apparatus 400 to connect to a PDN (e.g., the external network 150 of FIGS. 1 and 2) over an EPS (e.g., the EPS 120 of FIGS. 1 and 2). In this example, the WCD 420 establishes a default EPS bearer (e.g., EPS bearer 240 of FIG. 2), and may establish one or more dedicated bearers (e.g., EPS bearer 250 of FIG. 2) as described above.

The apparatus 400 may support “seamless” traffic offload between a 3GPP access and a non-3GPP access. In a seamless traffic offload, or simply a “seamless offload,” both the 3GPP access and the non-3GPP access traverse an EPC to access a PDN. Because both the 3GPP access and the non-3GPP traverse the EPC to reach the PDN, seamless offload supports IP address continuity between the accesses. Thus, any data buffered for transmission from the apparatus 400 via a first access (e.g., the 3GPP access) prior to a seamless offload to a second access (e.g., the non-3GPP access), can be removed from the buffer and rerouted for transmission from the apparatus 400 via the second access.

As described, the apparatus 400 may be capable of routing different, simultaneously active PDN connections through different access networks, which may be referred to as “Multi Access PDN Connectivity” or “MAPCON.” Here, the apparatus 400 may establish separate, simultaneously active PDN connections over a 3GPP access and a non-3GPP access and selectively transfer the PDN connections between the accesses to achieve seamless offload. Additionally or alternatively, the apparatus 400 may be capable of routing different IP flows to the same PDN connection through different access networks, which may be referred to as “IP flow mobility” or “IFOM.” Here, the apparatus 400 has the ability to, on a per IP flow basis, choose which access (e.g., 3GPP or non-3GPP) each IP flow should be supported on, and move IP flows between accesses to achieve seamless offload.

The apparatus 400 may also support “non-seamless” traffic offload between a 3GPP access and a non-3GPP access. In a non-seamless traffic offload, or simply a “non-seamless offload,” the 3GPP access traverses an EPC to access a PDN, but the non-3GPP access reaches the PDN via other mechanisms (e.g., the connection 180 of FIG. 1). Thus, the apparatus 400 may route specific IP flows to the PDN via the non-3GPP access without traversing the EPC. These specific IP flows may be identified via user preferences, the “local operation environment information,” and/or policies that may be statically pre-configured by the network operator on the apparatus 400 or dynamically set by the network operator via the access network discovery and selection function (ANDSF). IP address continuity is not supported for non-seamless offloads. Any data buffered for transmission from the apparatus 400 over the 3GPP access prior to a non-seamless offload to the non-3GPP access can be removed from the buffer and discarded upon offload. That is, IP packets of an offloaded IP flow that have the IP address assigned by the EPC's P-GW can be discarded, and thereafter IP packets with the IP address assigned by the non-3GPP access point can be routed via the non-3GPP access.

Turning again to FIG. 4, the processor 410 may control the overall operation of the apparatus 400. The processor 410 may be an application processor. The processor 410 may be (but is not limited to) one or more: central processing units (CPU), field programmable gate arrays (FPGA), application specific integrated circuits (ASIC), digital signal processors (DSP), or digital logic, and the like. The processor 410 may execute one or more applications, such as an operating system (OS), to control the overall operation of the apparatus 400, and to manage traffic offload in accordance with example embodiments of this disclosure. The processor 410 includes interfaces 411 and 412 for communicating with the WCD 420 and the WCD 430, respectively. The processor 410 also includes the offload controller 413, which is connected to each of the interfaces 411 and 412. The processor 410 may include one or more components (e.g., implemented in hardware, software, or any combination of hardware and software) in addition to the components shown in the embodiment of FIG. 4 without departing from the scope of this disclosure.

The offload controller 413 of FIG. 4, which is communicatively connected to the interfaces 411 and 412, may manage certain aspects of an offload procedure. For example, the offload controller 413 may: identify the type (e.g., seamless or non-seamless) of offload procedure requested; route or discard offloaded traffic from the WCD 420 to the WCD 430 (or vice versa); evaluate information (e.g., offload assistance information) to determine whether offload criteria is satisfied; and release a PDN connection, or portion thereof (e.g., one or more EPS bearers), after traffic is offloaded.

Offload assistance information may relate to, and the offload criteria may be based on, user preferences; network operator policies; network features, limitations, requirements, and/or operating conditions; UE features, limitations, requirements, and/or operating conditions; application features, limitations, requirements, and/or operating conditions; and the like. In one example, offload assistance information describes Wi-Fi signal strength, and the offload criteria includes a threshold Wi-Fi signal strength necessary for offload to Wi-Fi. The offload controller 413 may be implemented in hardware, software, or any combination of hardware and software. In one embodiment, the offload controller 413 is an application that may be executed by the processor 410.

While FIG. 4 depicts the offload controller 413 as disposed in the processor 410, other configurations are within the scope of this disclosure. As one example, an offload controller may be disposed in one or both of the WCDs 420 and 430. In this example, a WCD controller (e.g., the controller 422-described in more detail below) may comprise an offload controller, or vice versa. As another example, the offload controller 413 may be a component separate from and communicatively connected to the processor 410 and the WCDs 420 and 430.

The WCD 420 of FIG. 4 includes an interface 421, a controller 422, a storage device 423, a traffic classifier 424, a radio transceiver 425, and an antenna 426. The interface 421 is connected to the controller 422, and facilitates communication between the WCD 420 and the processor 410. The controller 422 is also connected to the storage device 423, the traffic classifier 424, and the radio transceiver 425. The radio transceiver 425 of FIG. 4 includes or is connected to the antenna 426, which transmits and receives electromagnetic radiation. In FIG. 4, the antenna 426 may represent one or more antennas—e.g., the antenna 426 may represent a multiple-input and multiple-output (MIMO) structure. As should be apparent to a person skilled in the art, the WCD 420 may include one or more components (e.g., implemented in hardware, software, or any combination of hardware and software) in addition to the components shown in the embodiment of FIG. 4 without departing from the scope of this disclosure. Some or all of the components of the WCD 420 may be implemented as a single integrated circuit, or may be implemented as different integrated circuits that are communicatively connected (e.g., via wires or wirelessly).

The controller 422—which is communicatively connected to the storage device 423, the traffic classifier 424, and the transceiver 425 in FIG. 4—may control the overall operation of the WCD 420, including (but is not limited to) receiving and executing instructions from the processor 410; providing instructions to the storage device 423, the traffic classifier 424, and the radio transceiver 425; forwarding data, packets, or any other information to the processor 410; and the like.

The storage device 423—which is communicatively connected to the controller 422, the traffic classifier 424, and the transceiver 425 in FIG. 4—may be any computer-readable storage device, including (but not limited to) a persistent memory device (e.g., read-only memory (ROM), flash memory, a magnetic storage device, an optical disc, and the like), a non-persistent memory device (e.g., random-access memory (RAM)), or any combination thereof. While depicted as disposed in the WCD 420, the storage device 423 may be a separate component of the apparatus 400 that is communicatively connected to the processor 410, and the WCDs 420 and 430. The storage device 423 may be included in a memory system of the apparatus 400, which may include one or more memory controllers to manage access to the memory system.

In one embodiment, the storage device 423 includes a transmission buffer or queue that temporarily stores IP packets before they are transmitted from the apparatus 400 via the transceiver 425 and the antenna 426. A transmission buffer may store IP packets based on routing information. In one example, a transmission buffer is logically partitioned into multiple sections, each section being associated with a PDN connection, an EPS bearer, and/or an IP flow. The logical partitions may be dynamically configured upon the establishment of a PDN connection, EPS bearer, and/or IP flow. In this example, IP packets are stored in one of the sections based on its routing information. So, in this example, IP packets to be transmitted to the Internet may be buffered in a first logical section, and IP packets to be transmitted to an IMS may be buffered in a second logical section.

The traffic classifier 424—which is communicatively connected to the controller 422, the storage device 423, and the transceiver 425 in FIG. 4—may manage certain aspects of an offload procedure. For example, the traffic classifier 424 may receive information indicating traffic to be offloaded (e.g., a PDN connection, a list of EPS bearer IDs, etc.), and identify the IP packet(s) of the traffic to be offloaded that are buffered for transmission. The traffic classifier 424 may report the identified IP packet(s) to other components, such as the processor 410 (e.g., via the controller 422), so that they may be removed from the buffer and handled as required by the offload procedure. The traffic classifier 424 may be implemented in hardware, software, or any combination of hardware and software. In one embodiment, the traffic classifier is an application, such as a software application or code, that may be executed by the controller 422.

Like the WCD 420 of FIG. 4, the WCD 430 includes an interface 431, a controller 432, a storage device 433, a traffic classifier 434, a radio transceiver 435, and an antenna 436. While the WCD 430 may be configured to implement a wireless access technology different than the wireless access technology implemented by the WCD 420, the components 431, 432, 433, 434, 435, and 436 may be the same, or similar, to the components 421, 422, 423, 424, 425, and 426, respectively. Because these components are discussed above, their description will not be repeated.

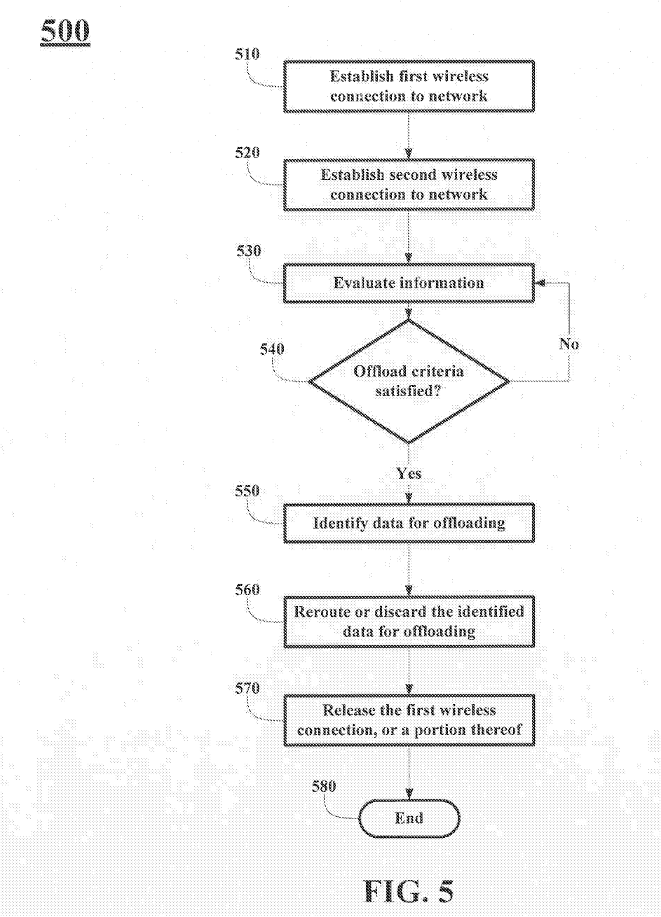

FIG. 5 illustrates an example method 500 for traffic offload from a first wireless connection to a second wireless connection. The method 500 may be implemented by any device or apparatus that supports coexisting wireless connections to an external network via different access technologies. Thus, the method 500 may be implemented by the UE 110 illustrated in FIGS. 1 and 2, or the apparatus 400 of FIG. 4; but the method 500 is not limited thereto. Additionally, each stage of the method 500 may represent a computer-readable instruction stored on a computer-readable storage device, which, when executed by a processor causes the processor to perform one or more operations.

The method 500 begins at stage 510, where a first wireless connection to an external network is established. Stage 510 may occur after the device (that is implementing the method 600) is powered on and within range of an access point (e.g., an eNodeB or another wireless access point). The first wireless connection may be established via a 3GPP access technology or a non-3GPP access technology, and may be established using the mechanisms described in accordance with FIGS. 1-4. In the case of a 3GPP access technology, establishing the first wireless connection will also result in the establishment of one or more EPS bearers. In the case of a non-3GPP access technology, the first wireless connection may traverse the EPC to reach the external network, and be a trusted access or an untrusted access (e.g., reaching the EPC via an ePDG). Alternatively, a non-3GPP access technology may connect to the external network without traversing the EPC. Once the first wireless connection is established at stage 510, data (e.g., IP packets) may be exchanged with the external network.

At stage 520, a second wireless connection to the external network is established. The second wireless connection may be established via a 3GPP access technology or a non-3GPP access technology; but, the second wireless connection is established via an access technology other than the access technology of the first wireless connection. The second wireless connection may be established using the mechanisms described in accordance with FIGS. 1-4.

At stage 530, information (e.g., offload assistance information) is evaluated to determine whether offload criteria are satisfied so that traffic may be offloaded from the first wireless connection to the second wireless connection. Offload assistance information may relate to, and the offload criteria may be based on, user preferences; network operator policies; network features, limitations, requirements, and/or operating conditions; UE features, limitations, requirements, and/or operating conditions; application features, limitations, requirements, and/or operating conditions; and the like.

If the offload criteria is satisfied at stage 540, the second wireless connection is available for offload and the method 500 proceeds to stage 550, and all traffic exchanged over with the first wireless connection, or a portion of the traffic exchanged over the first wireless connection (e.g., an IP flow or the IP flows associated with an offloaded IP bearer, etc.) may be offloaded. Otherwise, the method 500 may return to stage 530, and the offload criteria may be re-evaluated as the device's circumstances change (e.g., the device moves to a location with better wireless coverage). In some embodiments, stages 530 and 540 occur before stage 520. In these embodiments, after the first wireless connection is established at stage 510, the information is evaluated to determine whether the offload criteria is satisfied—satisfaction of the offload criteria resulting in the establishment of the second wireless connection.

At stage 550, data that is buffered for transmission from the device via the first wireless connection, and that is eligible for offloading to the second wireless connection is identified. As described above, the device may include a transmission buffer that stores IP packets prior to transmission over the first wireless connection. Each IP packet stored in the transmission buffer may include routing information that identifies the PDN, EPS bearer, and/or IP flow of the IP packet. The routing information may be used to identify IP packets stored in the transmission buffer that are eligible for offloading.

At stage 560, the data identified at stage 550 is removed from the transmission buffer and either rerouted for transmission over the second wireless connection (e.g., in a seamless offload), or discarded (e.g., in a non-seamless offload). Thereafter, at stage 570, the first wireless connection, or the portion of the first wireless connection that was offloaded (e.g., one or more EPS bearers, one or more IP flows, etc.) are released and the method 500 ends (at stage 580).

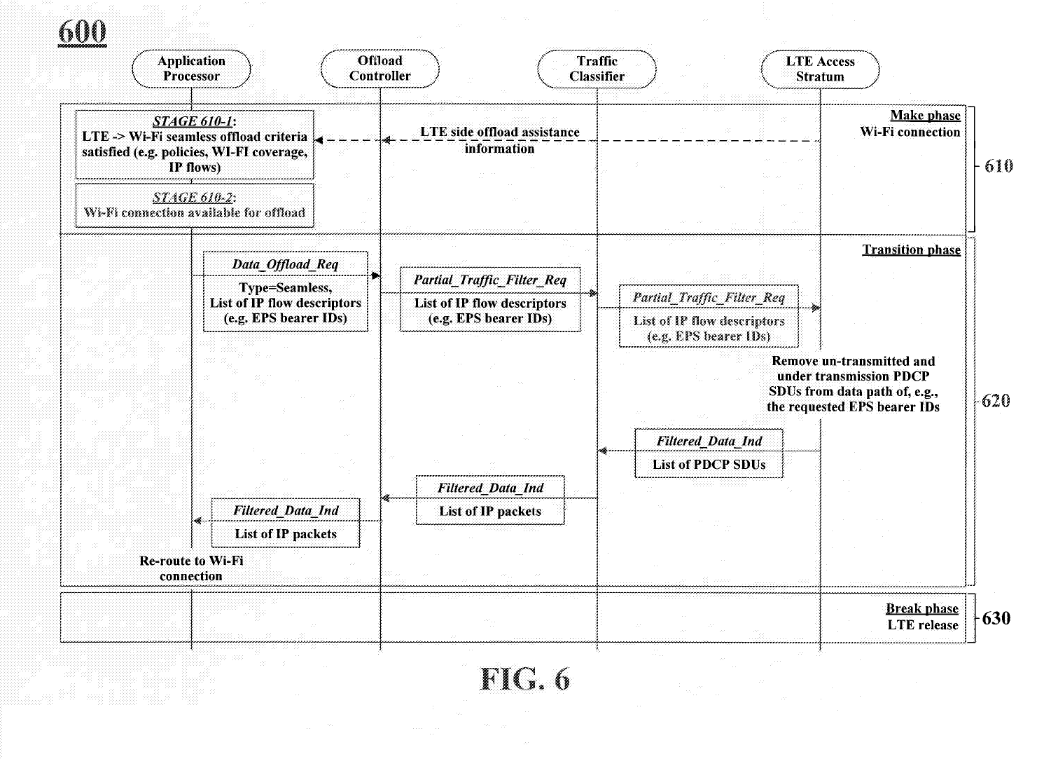

FIG. 6 illustrates an example message sequence chart (MSC) 600 for seamless offload from a first wireless connection to a second wireless connection. The message sequence shown in FIG. 6 may be exchanged by components of any device or apparatus that supports coexisting wireless connections to an external network via different access technologies. Thus, the message sequence shown in FIG. 6 may be exchanged by components of the UE 110 of FIGS. 1 and 2, or the apparatus 400 of FIG. 4; but the message sequence shown in FIG. 6 is not limited thereto. Also, the message sequence shown in FIG. 6 may be used in conjunction with the method 500 of FIG. 5; but is not limited thereto.

The seamless offload procedure depicted by the MSC 600 of FIG. 6 is described (below) as being implemented by a device supporting LTE connectivity and Wi-Fi connectivity; but it is not limited thereto. For example, the message sequence of the MSC 600 may be implemented to offload from any 3GPP access technology to any non-3GPP assess technology, or vice versa. Also, each message, stage, or phase illustrated in FIG. 6 may represent a computer-readable instruction stored on a computer-readable storage device, which, when executed by a processor causes the processor to perform one or more operations.

Before the message sequence shown in FIG. 6 is exchanged, a PDN connection over LTE is established and data may be exchanged over LTE. As such, one or more EPS bearers (e.g., a default EPS bearer and one or more dedicated EPS bearers) of the PDN connection over LTE will have been established (see, e.g., FIGS. 2 and 3). Additionally, data to be offloaded, as well as data that will not be offloaded, may be buffered in the LTE protocol stack data path under various stages of transmission. The seamless offload of FIG. 6 depicts a “make-before-break” procedure—i.e., a PDN connection via the EPC is established over Wi-Fi before the PDN connection (or a portion thereof) over LTE is released. The offload procedure of FIG. 6 includes three phases: a make phase 610, a transition phase 620, and a break phase 630.

In the make phase 610, offload assistance information is forwarded via the LTE access stratum to an application processor. The application processor or the offload controller (which may be included in the application processor) evaluates the offload assistance information to determine whether seamless offload criteria are satisfied. At stage 610-1, the application processor determines, or is informed, that the seamless offload criteria are satisfied. And at stage 620-1, the application processor determines that the Wi-Fi connection is available for offloading traffic associated with the LTE connection. Thereafter the message sequence of FIG. 6 enters the transition phase 620.

In the transition phase 620, the application processor generates a data offload request (e.g., Data_Offload_Req), and transmits the request to the offload controller. The data offload request may describe the type of offload requested—in this example the type is a seamless offload—and routing information of the data to be offloaded (e.g., IP flow descriptors (IDs), EPS bearer IDs, etc.) to be offloaded. Upon receiving the data offload request from the application processor, the offload controller generates a partial traffic filter request (e.g., Partial_Trafic_Filter_Req), and transmit this request to the traffic classifier. The partial traffic filter request may include routing information of the data to be offloaded. The traffic classifier forwards the partial traffic filter request to the LTE access stratum, where un-transmitted and under transmission packet data convergence protocol (PDCP) service data units (SDU) are removed from the data path for the data identified by the routing information.

Still considering the transition phase 620, the LTE access stratum generates a filtered data indication message (e.g., Filtered_Data_Ind), and transmits this message to the traffic classifier. The filtered data indication message may include a list of the PDCP SDUs removed from the data path. Upon receiving the filtered data indication message, the traffic classifier identifies a list of IP packets corresponding to the PDCP SDUs. The IP packets may be stored in a storage device (e.g., transmission buffer). The traffic classifier may generate another filtered data indication message (e.g., Filtered_Data_Ind), which may include a list of the identified IP packets, and transmits this message to the application processor. Upon receiving this message, the application processor reroutes the identified IP packets to the Wi-Fi connection for transmission. This may include removing the identified IP packets from a storage device (e.g., transmission buffer) associated with the LTE connection, and sending them to a storage device associated with the Wi-Fi connection.

Next, the message sequence shown in FIG. 6 enters the break phase 630, where the LTE connection or the portion of the LTE connection that was offloaded to the Wi-Fi connection is released.

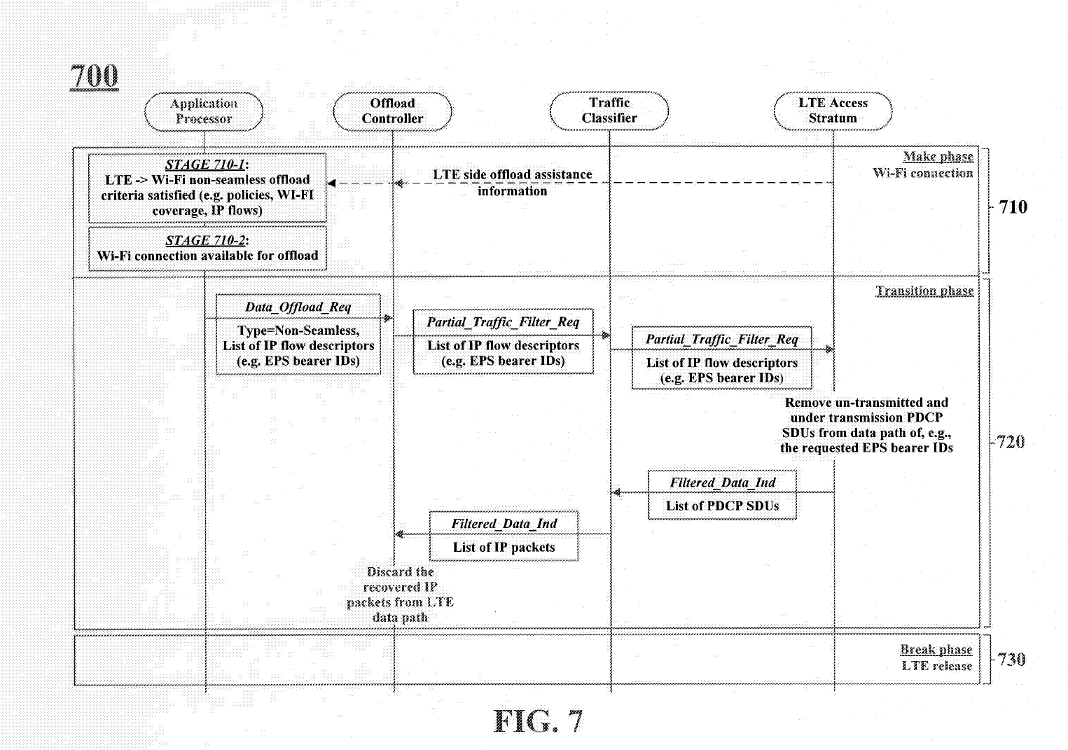

FIG. 7 illustrates an example message sequence chart (MSC) 700 for non-seamless offload from a first wireless connection to a second wireless connection. The message sequence shown in FIG. 7 may be exchanged by components of any device or apparatus that supports coexisting wireless connections to an external network via different access technologies. Thus, the message sequence shown in FIG. 7 may be exchanged by components of the UE 110 of FIGS. 1 and 2, or the apparatus 400 of FIG. 4; but the message sequence shown in FIG. 7 is not limited thereto. Also, the message sequence shown in FIG. 7 may be used in conjunction with the method 500 of FIG. 5; but is not limited thereto.

The non-seamless offload procedure depicted by the MSC 700 of FIG. 7 is described (below) as being implemented by a device supporting LTE connectivity and Wi-Fi connectivity; but it is not limited thereto. For example, the message sequence of the MSC 700 may be implemented to offload from any 3GPP access technology to any non-3GPP assess technology, or vice versa. Also, each message, stage, or phase illustrated in FIG. 7 may represent a computer-readable instruction stored on a computer-readable storage device, which, when executed by a processor causes the processor to perform one or more operations.

Before the message sequence shown in FIG. 7 is exchanged, a PDN connection over LTE is established and data may be exchanged over LTE. As such, one or more EPS bearers (e.g., a default EPS bearer and one or more dedicated EPS bearers) of the PDN connection over LTE will have been established (see, e.g., FIGS. 2 and 3). Additionally, data to be offloaded, as well as data that will not be offloaded, may be buffered in the LTE protocol stack data path under various stages of transmission. The seamless offload of FIG. 7 depicts a “make-before-break” procedure—i.e., a PDN connection is established over Wi-Fi before the PDN connection (or a portion thereof) over LTE is released. The offload procedure of FIG. 7 includes three phases: a make phase 710, a transition phase 720, and a break phase 730.

In the make phase 710, offload assistance information is forwarded via the LTE access stratum to an application processor. The application processor or the offload controller (which may be included in the application processor) evaluates the offload assistance information to determine whether non-seamless offload criteria are satisfied. At stage 710-1, the application processor determines, or is informed, that the non-seamless offload criteria are satisfied. And at stage 720-1, the application processor determines that the Wi-Fi connection is available for offloading traffic associated with the LTE connection. Thereafter the message sequence of FIG. 7 enters the transition phase 720.

In the transition phase 720, the application processor generates a data offload request (e.g., Data_Offload_Req), and transmits the request to the offload controller. The data offload request may describe the type of offload requested—in this example the type is a non-seamless offload—and routing information of the data to be offloaded (e.g., IP flow descriptors (IDs), EPS bearer IDs, etc.) to be offloaded. Upon receiving the data offload request from the application processor, the offload controller generates a partial traffic filter request (e.g., Partial_Trafic_Filter_Req), and transmit this request to the traffic classifier. The partial traffic filter request may include routing information of the data to be offloaded. The traffic classifier forwards the partial traffic filter request to the LTE access stratum, where un-transmitted and under transmission packet data convergence protocol (PDCP) service data units (SDU) are removed from the data path for the data identified by the routing information.

Still considering the transition phase 720, the LTE access stratum generates a filtered data indication message (e.g., Filtered_Data_Ind), and transmits this message to the traffic classifier. The filtered data indication message may include a list of the PDCP SDUs removed from the data path. Upon receiving the filtered data indication message, the traffic classifier identifies a list of IP packets corresponding to the PDCP SDUs. The IP packets may be stored in a storage device (e.g., transmission buffer). The traffic classifier may generate another filtered data indication message (e.g., Filtered_Data_Ind), which may include a list of the identified IP packets, and transmits this message to the offload controller. Upon receiving this message, the offload controller discards the identified IP packets.

Next, the message sequence shown in FIG. 7 enters the break phase 730, where the LTE connection or the portion of the LTE connection that was offloaded to the Wi-Fi connection is released.

It is to be appreciated that the Detailed Description section, and not the Summary and Abstract sections, is intended to be used to interpret the claims. The Summary and Abstract sections may set forth one or more but not all exemplary embodiments of the present disclosure as contemplated by the inventor(s), and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

What is claimed is:

1. An apparatus comprising:
a transmission buffer configured to store one or more IP packets for transmission over a first wireless connection to a network; and
a traffic classifier configured to identify at least one IP packet stored in the transmission buffer that is associated with an IP flow of the first wireless connection that is available to offload to a second wireless connection to the network.

2. The apparatus of claim 1, further comprising:
a processor configured to determine whether the IP flow of the first wireless connection is available to offload to the second wireless connection.

3. The apparatus of claim 2, wherein the processor is further configured to reroute the at least one IP packet identified by the traffic classifier for transmission over the second wireless connection.

4. The apparatus of claim 2, wherein the processor is further configured to discard the at least one IP packet identified by the traffic classifier.

5. The apparatus of claim 1, further comprising:
a first wireless connectivity device configured to establish the first wireless connection to the network; and
a second wireless connectivity device configured to establish the second wireless connection to the network.

6. The apparatus of claim 5, wherein the transmission buffer is disposed in the first wireless connectivity device.

7. The apparatus of claim 5, wherein the traffic classifier is disposed in the first wireless connectivity device.

8. The apparatus of claim 1, wherein the first and second wireless connections conform to long term evolution (LTE) and Wi-Fi, respectively, or the first and second wireless connections conform to Wi-Fi and LTE, respectively.

9. A method comprising:
identifying an IP packet, buffered for transmission over a first wireless connection to a network, that is associated with an IP flow of the first wireless connection that is available for offloading to a second wireless connection to the network; and
routing the identified IP packet for transmission over the second wireless connection or discarding the identified IP packet.

10. The method of claim 9, further comprising:
evaluating offload information to determine whether the IP flow of the first wireless connection is available to offload to the second wireless connection.

11. The method of claim 10, further comprising:
offloading the IP flow of the first wireless connection to the second wireless connection; and
releasing the IP flow of the first wireless connection.

12. The method of claim 9, further comprising:
establishing, by a first wireless connectivity device, the first wireless connection to the network; and
establishing, by a second wireless connectivity device, the second wireless connection to the network.

13. The method of claim 12, wherein the first and second wireless connections conform to long term evolution (LTE) and Wi-Fi, respectively, or the first and second wireless connections conform to Wi-Fi and LTE, respectively.

14. The method of claim 12, further comprising:
establishing, by the first wireless connectivity device, the first wireless connection to the network through an evolved packet core (EPC); and
establishing, by the second wireless connectivity device, the second wireless connection to the network through the EPC.

15. A computer-readable storage device comprising computer-readable instructions, which when executed by a processor causes the processor to perform operations comprising:
identifying an IP packet, buffered for transmission over a first wireless connection to a network, that is associated with an IP flow of the first wireless connection that is available for offloading to a second wireless connection to the network; and
routing the identified IP packet for transmission over the second wireless connection or discarding the identified IP packet.

16. The computer-readable storage device of claim 15, the operations further comprising:
evaluating offload information to determine whether the IP flow of the first wireless connection is available to offload to the second wireless connection.

17. The computer-readable storage device of claim 16, the operations further comprising:
offloading the IP flow of the first wireless connection to the second wireless connection; and
releasing the IP flow of the first wireless connection.

18. The computer-readable storage device of claim 15, the operations further comprising:
instructing a first wireless connectivity device to establish the first wireless connection to the network; and
instructing a second wireless connectivity device to establish the second wireless connection to the network.

19. The computer-readable storage device of claim 18, wherein:
the first and second wireless connections conform to long term evolution (LTE) and Wi-Fi, respectively, or
the first and second wireless connections conform to Wi-Fi and LTE, respectively.

20. The computer-readable storage device of claim 18, the operations further comprising:
instructing the first wireless connectivity device to establish the first wireless connection to the network through an evolved packet core (EPC); and
instructing the second wireless connectivity device to establish the second wireless connection to the network through the EPC.
